(19) United States
(12) Patent Application Publication
(10) Pub. No.: US 2007/0118259 A1
(43) Pub. Date: May 24, 2007

(54) VEHICLE SEAT

(75) Inventors: ADRIAN B. CHERNOFF, BOULDER, CO (US); STEVEN E. MORRIS, FAIR HAVEN, MI (US); JENNIFER P. LAWALL, WATEFORD, MI (US)

Correspondence Address: GENERAL MOTORS CORPORATION;LEGAL STAFF, MAIL CODE 482-C23-B21, P O BOX 300, DETROIT, MI, 48265-3000, US

(73) Assignee: GM GLOBAL TECHNOLOGY OPERATIONS, INC., Detroit, MI (US)

(21) Appl. No.: 11/535,512

(22) Filed: Sep. 27, 2006

Related U.S. Application Data
(60) Provisional application No. 60/724,189, filed on Oct. 6, 2005.

(51) Int. Cl. G06F 7/00; B60N 2/00; A47C 4/54

(52) U.S. Cl. 701/36; 296/63; 297/284.6

(57) ABSTRACT

A seat adjustment system for a vehicle includes a seat, a controller, and an occupant sensing system. The controller adjusts a pressure distribution of the seat in response to signals from the occupant sensing system to facilitate entry and/or egress from the vehicle.

### CROSS-REFERENCE TO RELATED APPLICATIONS

This application claims priority to U.S. Provisional Patent Application No. 60/724,189 filed on Oct. 6, 2005, and which is hereby incorporated by reference in its entirety.

### TECHNICAL FIELD

This invention relates to seats for vehicles, and more specifically to improvements in vehicle seats for enhancing occupant comfort.

### BACKGROUND OF THE INVENTION

Vehicle seats for supporting occupants within an occupant compartment of a vehicle are well known in the art. The typical vehicle seat has a steel frame covered with various padding materials. Inflatable air cells may be used in conjunction with the vehicle seat to provide adjustments to the contour of the seat and thus enhance the comfort of the occupant sitting in the vehicle seat. These inflatable air cells may be pneumatically controlled by the occupant.

### SUMMARY OF THE INVENTION

In an embodiment, a seat adjustment system for use with a vehicle includes a seat for supporting an occupant, a controller, and an occupant sensing system configured to determine a pressure distribution for an occupant present within the seat. The occupant sensing system is operable to transmit signals to the controller, with the controller operable to adjust the pressure distribution based on occupant preference. The seat may include at least one air-filled bladder, with the controller sending a controller signal to the air-filled bladder to adjust the pressure distribution within the air-filled bladder based upon the amount of air present within the air-filled bladder.

The controller signal may be transmitted to the air-filled bladder to adjust the pressure distribution when the vehicle door is opened or closed to facilitate entry and/or egress from the vehicle seat. In another embodiment, the controller signal may be transmitted independent of the vehicle door being opened or closed by using a remote entry device, such as a keyless entry device. In yet another embodiment, the controller signal may be transmitted manually by the occupant through an input device, such as a knob. In such a case, the occupant may change the pressure distribution while sitting in the vehicle seat. In any of the embodiments, the amount of air within the air-filled bladders may be pre-set based upon the occupant's preferences and stored within the controller so that the occupant does not have to adjust the pressure distribution to the air-filled bladders each time the occupant occupies the vehicle seat.

In another embodiment, an improved vehicle seat includes at least one outer bolster and a seat cushion, with the outer bolster configured to decrease in height and the seat cushion configured to increase in height in response to transmission of a controller signal to facilitate entry and/or egress from the vehicle seat. The vehicle seat may further include a controller, a first air-filled bladder disposed within the bolster, and a second air-filled bladder disposed within the seat cushion. To decrease the height of the bladder and increase the height of the seat cushion, the controller adjusts the amount of air within the first and second air-filled bladders. The controller signal may be transmitted independent of whether the vehicle door is opened or closed.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic plan view of a vehicle according to the present invention; and

FIG. 2 shows a schematic view of a vehicle seat from the vehicle of FIG. 1.

### DESCRIPTION OF PREFERRED EMBODIMENTS

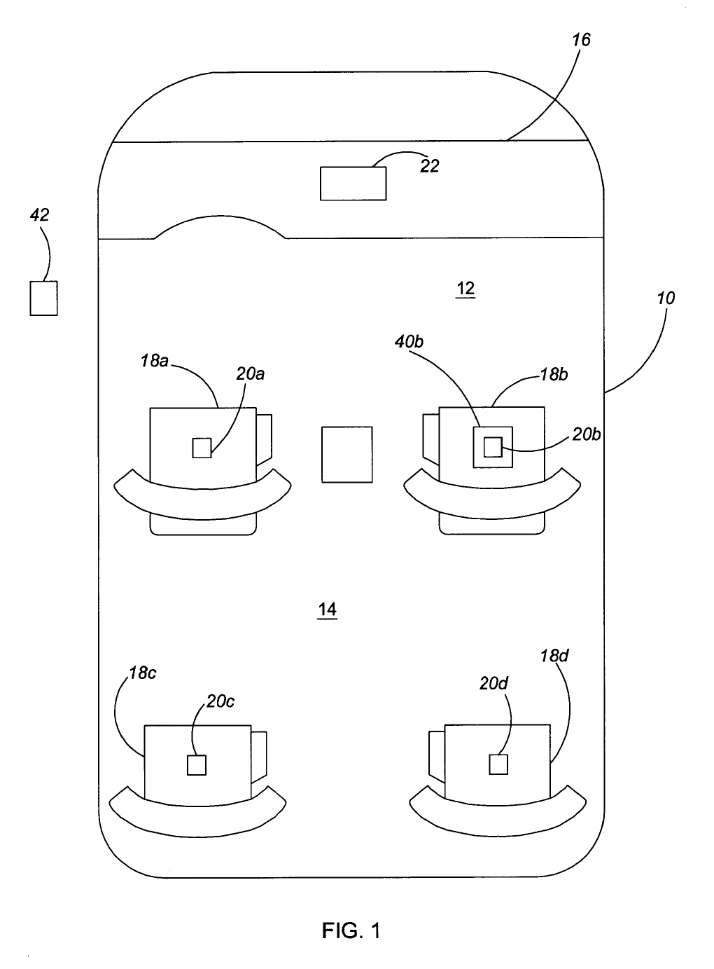

Referring to the drawings, wherein like reference numbers refer to like components, FIG. 1 shows a schematic view of a vehicle shown generally at 10. The vehicle includes an occupant compartment having a forward portion 12 and a rearward portion 14. An instrument panel 16 is located in the forward portion 12 of the occupant compartment. A plurality of seats 18a, 18b, 18c and 18d are disposed within the occupant compartment for supporting occupants within the occupant compartment. While FIG. 1 illustrates four seats, it should be noted that any number of seats may be disposed within the occupant compartment. Further, the seats may be arranged as individual seats, as shown, as rows of seats (not shown), or as a combination of individual seats and rows of seats (not shown).

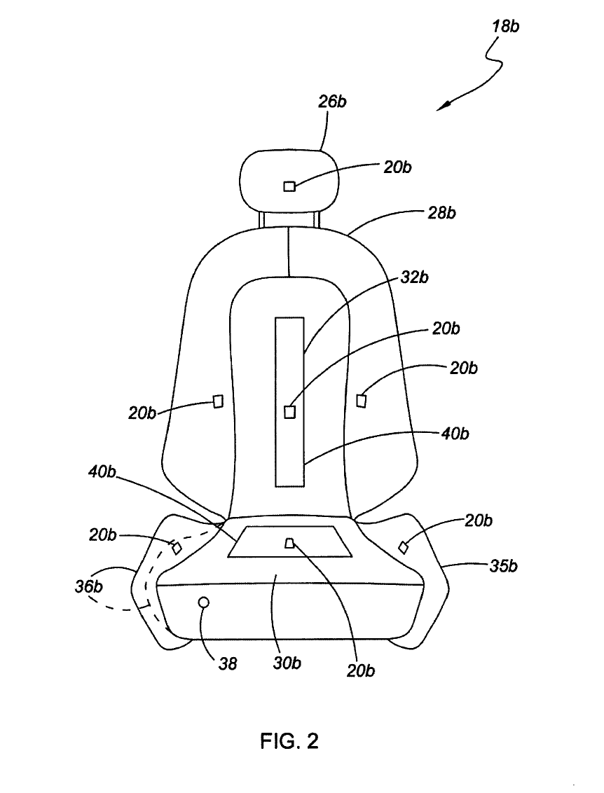

FIG. 2 shows a schematic view of a passenger seat 18b from the forward portion 12 of the occupant compartment of the vehicle 10 of FIG. 1. The seat 18b generally includes a head rest 26b, a seat back 28b, a seat cushion 30b, back inner bolster 32b, back outer bolster 34b, back inner bolster 35b and cushion outer bolster 36b. The seat back 28b and the seat cushion 30b each further include an air-filled bladder 40b operative as an expandable volume. It should be noted that the occupant sensing system may include air-filled bladders anywhere within or around the seats 18a-d as necessary to practice the invention.

The back outer bolster 34b and the cushion outer bolster 36b are disposed on an exit side of the seat 18b, that is, the side an occupant would use to enter and exit the vehicle. Thus, a driver seat 18a (i.e., from FIG. 1) would appear substantially similar to the seat 18b shown in FIG. 2, but with the inner bolsters on the opposite or inner side of seat 18a shown in FIG. 1 and the back and cushion outer bolsters on the opposite or exit side of the seat 18a shown in FIG. 1. The seat 18b may further include additional bolsters, foot rests, and/or arm rests as known in the art.

An occupant sensing system includes sensors 20a, 20b, 20c and 20d disposed within or around the respective seats 18a-d for detecting the presence or absence of an occupant within the respective seats 18a-d, and preferably for detecting a pressure profile of the occupant. The pressure profile may include the weight and position of an occupant present within the respective seats 18a-d. It can be appreciated that sensors 20a-d may be disposed anywhere within or around the respective seats 18a-d as necessary for occupant sensing.

The sensors 20a-d transmit detected parameters to a controller 22 as shown in FIG. 1. The controller 22 analyzes the detected parameters received and sends a controller signal to modify various vehicle conditions in response to the detected parameters as described herein. It should be noted that the occupant sensing system may include sensors anywhere within or around the respective seats 18a-d as necessary to practice the invention.

The controller 22 adjusts seat comfort based on parameters sensed by the respective sensors 20a-d within the respective seats 18a-d. For example, the sensors 20b within seat 18b preferably determine the size and weight of an occupant, thereby allowing the controller 22 to determine the pressure distribution of the occupant within the seat 18b. The sensors 20b further detect the pressure in each of the seat portions, i.e. the head rest 26b, the seat back 28b, the seat cushion 30b, the inner bolsters 32b, the back outer bolster 34b, the back inner bolster 35b and the cushion outer bolster 36b. Furthermore, the sensors 20b may detect localized pressure points within each seat portion. For example, if the occupant has a wallet in a back pocket, the occupant sensing system may detect the increased or different pressure within the seat cushion 30b at that location.

Sensors 20b may allow the occupant to adjust the amount of air in the air-filled bladders 40b for seat comfort and to facilitate entry and egress from the vehicle. For instance, the occupant may prefer to adjust the amount of air within air-filled bladder 40b of seat cushion 30b when entering or exiting the vehicle. Once the occupant has entered the vehicle, he or she may choose to adjust the amount of air in the air-filled bladders 40b depending upon the comfort level of the seat 18b. The sensors 20b may also allow the occupant to choose pre-set seat firmness; for example, the occupant could choose between settings such as soft, medium, firm and stiff. Additionally, sensors 20b may allow the occupant to choose between different driving styles, i.e., city, sport, and freeway. The controller 22 then adjusts the pressure within the air-filled bladders 40b of the various seat portions based on the combination of the occupant's preferred firmness and/or driving style and the sensed pressure within each seat portion as determined by the occupant sensing system.

The various settings may further be storable within the controller and activated by the occupant when desired. Storing the various settings within the controller may allow more than one occupant of the vehicle to store his/her respective desired seat settings. An embodiment for activating the various settings, based upon a condition indicative of ingress or egress from the vehicle, may include an automatic adjustment of the air-filled bladders 40b when the vehicle door is opened or closed, or when a key (not shown) is engaged within the vehicle door's lock (not shown). Opening or closing the vehicle door, or engaging the key, may send a signal to sensors 20b via controller 22 to adjust the amount of air in the air-filled bladders 40b to facilitate entry or egress from the vehicle. The occupant may program the controller 22 to include pre-determined levels of air in the air-filled bladders 40b so that once the vehicle door is opened or closed, or the key is engaged within the lock, the air-filled bladders 40b are adjusted according to the occupant's desired settings. Another embodiment for activating the various settings may include putting a running vehicle into Park, which is typically indicative of the occupant exiting the vehicle.

Another embodiment for activating the various settings may include engaging a remote device 42, such as a keyless-entry device, also commonly known as a key fob. Activating the remote device 42 allows the occupant to adjust the settings for seat 18b well in advance of entering the vehicle. In addition, more than one remote device 42 may be associated with the vehicle 10, thereby allowing for more than one occupant to program controller 22 with pre-determined settings. The controller 22 may be able to determine the appropriate setting based upon the transmission of the particular remote device 42 that is activated or engaged.

With reference to FIG. 2, a further embodiment for activating the various settings may include engaging an input device 38, such as a knob, a lever, or the like. Input device 38 allows the occupant to adjust the air in the air-filled bladders 40b while occupying the seat 18b. In such a situation, the occupant may be able to manually adjust the amount of air in the air-filled bladders 40b independent of the pre-determined settings for seat 18b. For instance, seat 18b may have already been automatically adjusted when the vehicle door was opened, but the occupant may want to further adjust the seat cushion 30b after occupying the vehicle seat. Engaging input device 38 may allow the occupant to fine tune the seat 18b to maximize seat comfort.

In another embodiment, the back outer bolster 34b and/or the cushion outer bolster 36b are configured to automatically adjust to an optimal position for ingress and egress. Additionally, the seat cushion 30b may also adjust in conjunction with the bolsters 34b, 36b. Preferably, the height of the outer bolsters 34b, 36b decreases, while the height of the seat cushion 30b increases prior to the occupant entering or exiting the vehicle. For example, the bolsters 34b, 36b and the seat cushion 30b may include air-filled bladders, with the controller 22 adjusting the amount of air within the air-filled bladders to flatten the bolsters 34b, 36b and raise the seat cushion 30b. In addition to flattening, the outer bolsters 34b, 36b may roll downward to further facilitate entry and egress. FIG. 2 illustrates two positions for outer bolster 36b, with the solid line indicating outer bolster 36b in an inflated position to optimize seat comfort, and the phantom line indicating outer bolster 36b in a deflated position to assist in ingress and egress from within the vehicle seat.

Adjustment may be tied to occupant preference, i.e., the amount of flattening and/or raising may be selected by a seat occupant, as by turning knob 38 or pre-entering the desired levels of air adjustment. Adjustment may be initiated when a vehicle door is opened, thereby signifying entry or egress is likely to occur, and/or may utilized in a seat which also moves fully rearward to facilitate entry and egress to and from the vehicle.

While the features of the present invention have been shown with respect to seat 18b, it should be appreciated that the respective outer bolsters and the seat cushion of any of the seats 18a-d could be configured to automatically adjust under certain conditions to facilitate entry and/or egress. Further, it should be noted that while the invention has been described with respect to seat 18b, any of the seats 18a-d can utilize these features within the scope of the present invention.

While the best mode for carrying out the invention has been described in detail, it is to be understood that the terminology used is intended to be in the nature of words and description rather than of limitation. Those familiar with the art to which this invention relates will recognize that many modifications of the present invention are possible in light of the above teachings. It is, therefore, to be understood that within the scope of the appended claims, the invention may be practiced in a substantially equivalent way other than as specifically described herein.

1. A seat adjustment system for use within a vehicle comprising:
a vehicle seat; and
a controller;
wherein said controller is operative to automatically adjust an expandable volume in said seat in anticipation of entry or egress with respect to said vehicle seat to ease entry or egress.

2. The seat adjustment system of claim 1, wherein said vehicle seat includes at least one air-filled bladder operative as said expandable volume, and wherein said controller adjusts the amount of air within said at least one air-filled bladder, thereby adjusting said air pressure distribution.

3. The seat adjustment system of claim 1, further comprising an occupant sensing system including at least one sensor disposed with respect to said vehicle seat and configured to detect the presence or absence of an occupant on the vehicle seat, said at least one sensor operable to transmit a signal to said controller.

4. The seat adjustment system of claim 3, wherein said at least one sensor detects a pressure profile of an occupant on the vehicle seat and transmits said signal to said controller dependent upon said pressure profile of said occupant.

5. The seat adjustment system of claim 1 further comprising a vehicle door configured to transmit a signal to said controller indicating one of said vehicle door being opened or closed, and wherein said controller adjusts said expandable volume based upon said vehicle door being opened or closed in order to facilitate ingress or egress.

6. The seat adjustment system of claim 1 further comprising a remote device configured to transmit a signal to said controller when activated, wherein said controller adjusts said expandable volume when said remote device is activated.

7. The seat adjustment system of claim 1 further comprising an input device configured to transmit a signal to said controller when activated, wherein said controller adjusts said expandable volume when said input device is activated.

8. A vehicle seat comprising:
at least one outer bolster; and
a seat cushion;
wherein said at least one outer bolster is configured to decrease in height and said seat cushion is configured to increase in height in response to transmission of a signal to facilitate at least one of entry and egress with respect to said vehicle seat.

9. The vehicle seat of claim 8 further comprising a vehicle door, wherein said signal is transmitted when said vehicle door is opened.

10. The vehicle seat of claim 8, further including:
a controller;
a first air-filled bladder disposed with respect to said at least one outer bolster; and
a second air-filled bladder disposed with respect to said seat cushion;
wherein said controller adjusts the amount of air within said first and second air-filled bladders to decrease the height of said least one outer bolster and increase the height of said seat cushion for entry or egress.

11. A vehicle seat comprising:
a vehicle seat having a seat back and a seat cushion;
a controller; and
wherein said controller is operative to automatically adjust an air pressure distribution in said seat back and said seat cushion in anticipation of entry or egress with respect to said vehicle seat to ease entry or egress

12. The vehicle seat of claim 11, wherein said seat back and said seat cushion each includes at least one air-filled bladder, and wherein said controller adjusts the amount of air within said at least one air-filled bladder, thereby adjusting said pressure distribution.

13. The vehicle seat of claim 11 further comprising a vehicle door configured to transmit a signal to said controller indicating one of said vehicle door being opened or closed, and wherein said controller adjusts said pressure distribution based upon said vehicle door being opened or closed in order to facilitate ingress or egress.

14. The vehicle seat of claim 11 further comprising a remote device configured to transmit a signal to said controller when activated, wherein said controller adjusts said pressure distribution when said remote device is activated.

15. The vehicle seat of claim 14, wherein said remote device is a key-less entry device.

16. The vehicle seat of claim 11 further comprising an input device configured to transmit a signal to said controller when activated, wherein said controller adjusts said pressure distribution when said input device is activated.

17. The vehicle seat of claim 16, wherein said input device may be activated when said occupant is present within said vehicle seat.

18. A method of adjusting a vehicle seat based upon a condition indicative of ingress or egress of an occupant within a vehicle, comprising:
determining said condition indicative of ingress or egress of said occupant with respect to said seat;
transmitting at least one signal to a controller based upon said condition; and
altering an air pressure distribution of at least one air bladder within said vehicle seat based upon said signal in order to facilitate ingress or egress.

19. The method according to claim 18, wherein said vehicle seat further includes at least one outer bolster and a seat cushion, wherein said altering said pressure distribution includes the steps of decreasing the height of said at least one outer bolster and increasing the height of said seat cushion in response to said signal.

20. The method according to claim 18, wherein said condition indicative of ingress or egress includes one of activating an input device, activating a remote device, opening or closing a vehicle door, and putting said vehicle in park.
